(19) United States
(12) Patent Application Publication
(10) Pub. No.: US 2005/0163678 A1
(43) Pub. Date: Jul. 28, 2005

(54) Apparatus and methods for therapeutic use of ozone

(75) Inventors: Allen D. Clawson, Cedar City, UT (US); Dennis Lavelle, Paso Robles, CA (US); Hugo Haselhuhn, Paso Robles, CA (US)

Correspondence Address: STOUT, UXA, BUYAN & MULLINS LLP, 4 VENTURE, SUITE 300, IRVINE, CA, 92618, US

(73) Assignee: DEL INDUSTRIES, INC., San Luis Obispo, CA (US)

(21) Appl. No.: 11/010,220

(22) Filed: Dec. 8, 2004

Related U.S. Application Data
(60) Provisional application No. 60/527,972, filed on Dec. 9, 2003.

(51) Int. Cl. B01J 19/08

(52) U.S. Cl. 422/186.07

(57) ABSTRACT

An apparatus is provided for therapeutic treatment of a body part for example, adult human feet, utilizing ozonated water. The apparatus includes a container holding a quantity of ozonated water and sized to contain a body part, for example at least one adult human foot. The apparatus further includes a cover secured to the container, an ozonated water generating system mounted to the container and an ozone destruction assembly for reducing undissolved ozone released from the ozontaed water in the container. The ozonated water generating system includes an ozone gas generator positioned to pass ozone gas into a stream of water being drawn into a water pump. Mixing of ozone gas and water flowing through the pump occurs in the water pump and this therapeutic ozonated water mixture is passed into the container.

### RELATED APPLICATIONS

This application claims the benefit of U.S. provisional patent application No. 60/527,972, filed Dec. 9, 2003, the entire disclosure of which is incorporated herein by this specific reference.

### FIELD OF THE INVENTION

The present invention relates to systems for therapeutic treatment of a body part using ozone, and more particularly, to an apparatus and method adapted for the treatment of a body part, for example, but not limited to, treatment of a body part infected with fungi, bacteria, or other microorganism, using ozone as a disinfectant or for other therapies.

### BACKGROUND OF THE INVENTION

Fungal or bacterial infections are known to be problems in the human foot. Athletes' foot is one such example of a prevalent foot fungus. Once infected, it is often rather difficult to rid the feet of the infection or fungus. While over the counter foot powders and ointments are available, and even several prescription products are on the market, however, such products have been known lose their effectiveness over time, prove costly, or may cause unwanted side effects.

It has been known to use ozone to treat swimming pools, spas, hot tubs and the like to maintain the water therein in a sanitary manner. For example, in order to treat a spa for typical, non-acute, contamination the concentration of ozone used to sanitize the water is often in the range of about 0.1 to about 0.2 parts per million (ppm) based on the weight of ozone per volume of water.

It has been discovered that the human foot, infected with fungi, bacteria or other microorganism, can be treated by contact with ozone in a liquid medium. Martin et al., U.S. Pat. No. 5,834,031, the disclosure of which is incorporated herein in its entirety by this reference, describes a method and apparatus for sanitizing a foot infected with fungi utilizing ozonized water. However, an alternative means for introducing ozone into a transportable bath, for therapeutic purposes, remains desirable.

### SUMMARY AND OBJECTS OF THE INVENTION

The present invention provides apparatus and methods for therapeutic treatment of a body part, for example such as human feet, infected with fungi, bacteria or other microorganisms, utilizing contact of the foot with ozone dissolved in a liquid medium. The amount of ozone is sufficient to kill at least a portion of the infecting fungus, bacteria or other microorganism. The present invention provides for a very cost effective and efficient way to provide therapeutic relief to a body part, such as a person's foot, with few if any side effects. The treatment effectively reduces or eliminates the infection without staining or discoloring the foot. The system can be used repeatedly, over long time intervals with no reduction of its effectiveness or any undue detriment to the individual using the device.

In one broad embodiment, the apparatus comprises a container, an ozone generator and a transfer assembly. The container is adapted to hold a quantity of liquid aqueous medium, for example, in the range of about 0.5 or about 1 gallon to about 3 or about 5 gallons or about 10 gallons, and is sized to permit only a portion of an adult human body to be placed in the container. The ozone generator is sized and adapted to produce sufficient ozone to effectively ozonate the liquid aqueous medium, that is to provide a concentration of ozone to destroy fungi, bacteria or other harmful microorganisms in the liquid aqueous medium in the container.

Generally, the concentration of dissolved ozone in the liquid aqueous medium is sufficient to provide at least some therapeutic benefit to a user of the apparatus. For example, in some embodiments, the apparatus is structured to be effective to produce a liquid aqueous medium in the container that has an ozone concentration that will disinfect or sanitize a body part immersed in the liquid aqueous medium. In some embodiments of the invention, the apparatus is effective to produce a liquid aqueous medium in the container that has a dissolved ozone concentration effective to destroy fungus or destroy microbial infections on the body part immersed in the liquid aqueous medium. For example, the apparatus may be structured such that the container is sized to receive a human foot fully immersed in liquid aqueous medium in the container, and the transfer assembly and the ozone generator are effective to cause the liquid aqueous medium in the container to have a dissolved ozone concentration effective to treat a microbial infection on a human foot, for example, athlete's foot fungus on a human foot.

Typically the concentration of ozone present in the liquid aqueous medium in the container is preferably greater than the concentration of ozone required to effectively sanitize water in a spa. For example, the concentration of ozone present in the liquid aqueous medium in the container is at least about 2 times greater, or 5 time greater, or 10 times greater, or at least about 50 times greater, and still more preferably at least about 100 times greater than the concentration of ozone to effectively sanitize water in a spa.

The transfer assembly cooperates with the container and the ozone generator to pass ozone-containing gas produced by the ozone generator to the liquid aqueous medium in the container.

In the preferred embodiment, the transfer assembly utilizes the suction capacity of the water pump to draw ozone-containing gas from the ozone generator and to pass this ozone-containing gas into the water pump, where the ozone is combined and mixed with an aqueous fluid, for example water, being provided to the pump, and this ozone-aqueous mixture is then introduced into the liquid aqueous medium in the container.

The apparatus may further include a cover member structured to be secured, for example removably secured, to the container. The cover member may be integral with the container or separate from the container and is positioned so that it at least partially covers the container, preferably so that it at least partially covers the liquid aqueous medium in the container. The cover member is effective to reduce evaporation of the liquid aqueous medium and/or contain undissolved ozone-containing off-gas that may be released from the liquid aqueous medium. The cover member may include hole or opening to permit a body part, for example the feet of a human, to be placed in the container through the opening.

An ozone destruction assembly may also be included in the present invention. The ozone destruction assembly is positioned relative to the liquid aqueous medium in the container so as to destroy ozone gas which may be released from the liquid aqueous medium in the container. The ozone destruction assembly includes an ozone destroying element and a mechanism for moving, for example drawing, air that may contain undissolved ozone gas, into contact with the ozone destroying element.

In another aspect of the present invention are methods for therapeutic treatment of a body part, for example, but not limited to a body part infected with fungi, bacteria or other microorganisms, the method comprising contacting a body part to be treated with a liquid aqueous medium, for example, in a container of an apparatus disclosed herein. Dissolved within the liquid aqueous medium is a therapeutically effective amount of ozone, and the contacting is conducted at conditions, for example, for a period of time, at a temperature and the like, effective to therapeutically treat the body part, for example effective to kill at least a portion of the fungus, bacteria or other microorganism affecting the body part. Preferably ozone is the only or sole effective component present in the liquid aqueous medium. The concentration of ozone present in the liquid aqueous medium in the container is preferably greater, more preferably at least about 10 times or at least about 20 times and still more preferably at least about 50 times greater or at least about 100 times greater than the concentration of ozone to effectively sanitize water in a spa. In order to effectively treat the infection it is preferred that the contacting step be repeated at least once more preferably repeated as often, for example, one a daily, semiweekly, or weekly basis, or as needed, to treat the body part, for example, to eliminate the infection.

It is therefore a primary object of the present invention to provide an apparatus and method for treatment of a body part using ozone dissolved in a liquid aqueous medium.

Each and every feature described herein, and each and every combination of two or more of such features, is included within the scope of the present invention provided that the features included in such a combination are not mutually inconsistent.

With these and other objects, advantage and features of the invention that may become hereinafter apparent, the nature of the invention may be more clearly understood by reference to the following detailed description of the invention, the claims, and the accompanying drawings.

### BRIEF DESCRIPTION OF THE DRAWINGS

The preferred embodiments of this invention will be described in detail, with reference to the following figures.

FIG. 1 is a top front view, in perspective, of one embodiment of the apparatus in accordance with the present invention, with the cover shown separated from the container body for illustrative clarity;

FIG. 2 is a somewhat schematic illustration of an ozone generator and transfer assembly suitable for use in the present invention; and

FIG. 3 is a partial view, partly in cross section, of an ozone destruction assembly of the apparatus shown in FIG. 1

### DETAILED DESCRIPTION

Referring now to the drawings, and in particular FIG. 1, a treatment apparatus in accordance with the invention is shown generally at 10. The apparatus includes a container 112, a cover 114, a first mounted member 116, and may also include a second mounted member 118 and a water circulation system which is adapted to transfer an ozonated water stream from an ozone generator into the liquid aqueous medium 122 of the container body 112. Both the first mounted member 116 and the second mounted member 118 are secured or mounted to the container 112 or the cover 114. In general, all components of apparatus 10 are made of any suitable materials of construction, preferably materials of construction which are at least to some extent resistant to the oxidative properties of ozone. Particularly useful materials of construction for the container 112, cover 114 and housings of the first and second mounted members 116 and 118 are polymeric materials, for example polyvinyl chloride (PVC), acrylonitrile-butadiene-styrene (ABS) polymers, polycarbonates and the like.

It is to be understood that although each of the components of the present system is shown and/or described individually, two or more components of apparatus 10 can be integrally formed. Furthermore, a great many configurations are suitable for the present apparatus, such as apparatus 10. Each of these different configurations, for example, in which two or more of these components are integrally formed, are included within the scope of the present invention.

The container 112 comprises a container body 113 defining a hollow space in which a quantity of liquid aqueous medium 122 is provided. The container body 112 is sized and adapted so that a body part of a human can be placed in the hollow space and be submerged or immersed in the liquid aqueous medium 122, for example, a pair of adult human feet. The space in which the liquid aqueous medium 122 is placed is partially defined by the inner wall of the container body 112. The container body 112 may have any suitable configuration, for example, the container body may have a square or rectangular top/bottom configuration with each side having a dimension in the range of about 10 inches to about 18 inches or about 20 inches with about 14 inches being particularly useful. The height of the liquid aqueous medium 122 in the container body 112 may be in the range of about 2 inches to about 6 inches or about 8 inches and up to about 10 inches or even about 12 inches. The container body 112 can effectively hold about 0.5 gallons to about 2.5 gallons or about 1.5 gallons of liquid aqueous medium 122. Based on the present dimensions described herein, it is clear that the present apparatus 10 is substantially smaller than a swimming pool, spa, hot tub and the like.

The cover 114 may include an opening 130 which extends from the first end of the cover and terminates well before the opposed second end of the cover 114. This opening 130 is sized and adapted so that the desired body part, for example a pair of adult human feet, can be passed through the opening 130 and into the liquid aqueous medium 122 held in the container body 112. The cover 114 is also configured, at least to some extent, to reduce an amount of off-gas, for example, air containing undissolved ozone gas that may be released from the liquid aqueous medium during use of the apparatus 10.

First mounted member 116 is shown secured to the outer wall of the container body 113. Alternatively, first mounted member 116 may be secured to the inner wall of the container body 113 within the scope of the present invention. The securement can be accomplished in any suitable manner, for example, by means of screws, bolts, adhesive or the like.

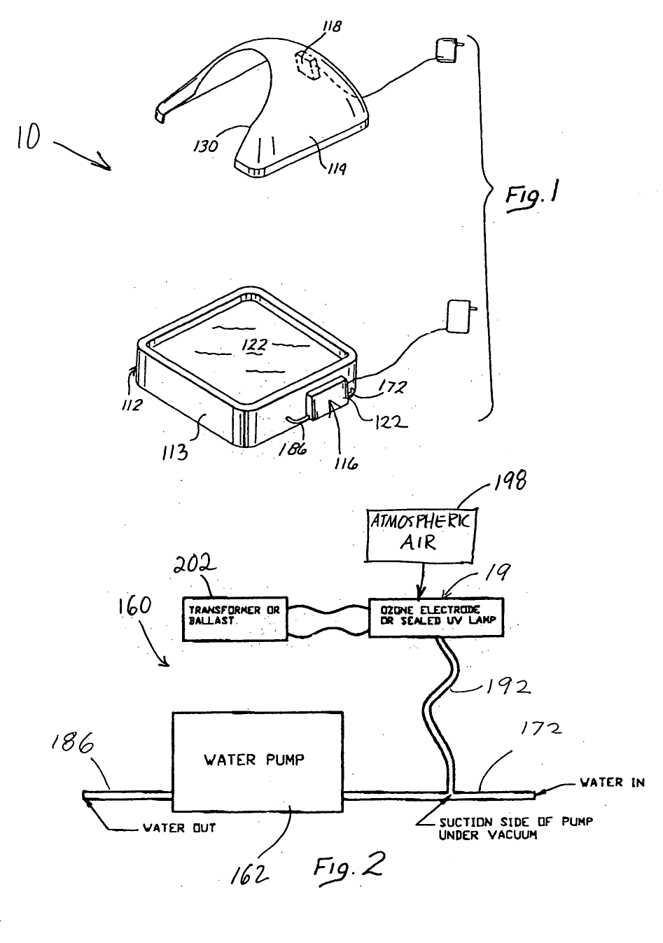

Turning now as well to FIG. 2, in the specific embodiment of the invention shown, first mounted member 116 includes a first member housing 122 which contains a transfer assembly 160 comprising a water pump 162 effective to pump an aqueous media, for example water, through an inlet conduit 172 and through an outlet conduit 186. The first member housing 122 also contains an ozone generator 190 having an ozone gas conduit 192 that joins or provides fluid communication between an ozone generator 190 and the inlet conduit 172. The suction of the water pump 162 causes a vacuum to occur at or near where the inlet conduit 172 and ozone gas conduit 192 connect. This vacuum is sufficient to pull ozone-containing gas through ozone gas conduit 192 and into the inlet conduit 172 and the transfer assembly is effective to combine the ozone-containing gas with aqueous media, for example water, being provided to the water pump 162 by means of inlet conduit 172. The transfer assembly 160 may be structured such that the inlet line 172 provides fluid communication between the container 112 and the water pump 162 to facilitate circulation of the liquid aqueous medium in the container 112 through the water pump 162. In other words, in the embodiment shown, the aqueous medium in inlet conduit 172 is an amount of liquid aqueous medium being drawn from the container 112 by means of the water pump 162, which is ozonated, or further ozonated, when combined with ozone-containing gas from gas line 192 and further mixed in the water pump 124. The combined ozone-aqueous mixture is then passed from the water pump 162 through the outlet conduit 186 and is introduced into the liquid aqueous medium 122 in container 112. The outlet conduit 186 may be equipped with a jet nozzle or similar device (not shown) which can direct the ozone-aqueous mixture to a specific region of the container body 112.

In one embodiment, the vacuum or suction caused in the inlet conduit 172 is sufficient to pull atmospheric air 198 into ozone generator 194 so that the ozone generator 194 produces ozone-containing gas which then passes through ozone gas conduit 192 and into the inlet conduit 172 and into the water pump 124.

The ozone generator 194 can be of any conventional and/or well known design. For example, the ozone generator 194 may be connected to a transformer or ballast 202 and may include a sealed ultraviolet light lamp and/or electrode, both of which are known to produce ozone in the desired amounts. A specific ozone generator which is particularly useful in the present invention is an ozone generator sold by Del Industries under the trademark ZO-151. Another useful ozone generator is one that employs a relatively small size chip electrode in combination with a transformer to generate ozone from air using an electric discharge.

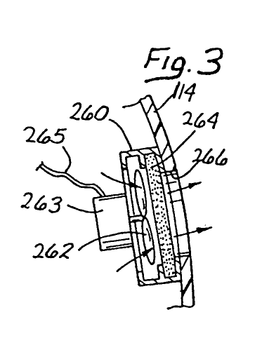

Second mounted member 118, shown in FIGS. 1 and 3, is an ozone destruction assembly that is an optional feature of the apparatus 10 of the present invention, and is effective to destroy undissolved ozone gas. Second mounted member 118 is shown to be secured, e.g., adhesively secured, to an inner surface of cover 114. With specific reference to FIG. 3, second mounted member 118 includes second member housing 260, a fan 262 and a quantity of activated carbon 264. The fan 262, powered by conventional electric motor 263 (which receives power through electric wire 265) is sized and adapted to urge ozone-containing off gases which is released from the liquid aqueous medium 122 in container body 112 to move toward the activated carbon 264. The activated carbon 264 is positioned adjacent an aperture 266 in cover 114. Thus, when the fan 262 is operating, the off-gases from liquid aqueous medium 122 pass through and come in contact with the activated carbon 264. The product resulting from this contacting, which is largely oxygenated air is then exhausted through aperture 266 to the general environment surrounding apparatus 10. As the ozone gas released from liquid aqueous medium 122 contacts the activated carbon 264, the ozone is destroyed or otherwise rendered innocuous so that excessive amounts or concentrations of ozone are not admitted to the general atmosphere surrounding apparatus 10.

Apparatus 10 functions as follows. When it is desired to treat a portion of the human body, for example, the feet of an adult human, that are infected with fungi, bacteria or other microorganisms, the apparatus 10 is prepared for use. A suitable quantity of water, for example, tap water, distilled water, deionized water or the like, is placed in the container body 112. This water should be at a suitable temperature, for example, in the range of about 20° C., or about 25° C. to about 35° C. or about 40° C., so that the human being placing his or her body part into the water is comfortable. The cover 114 is then applied to the container 112 and the water pump 162 and ozone generator 194 are started.

The person then places the portion of his or her body to be therapeutically treated into through the opening 130 in cover 114 and into the liquid aqueous medium 122. Ozone gas is continuously generated by the ozone generator and passed into the liquid aqueous medium 122. Water pump 162 pulls water from the body of water in the container 112 where it is combined with ozone-containing gas. The ozone gas and the water are mixed and combined in the water pump which forces the ozone aqueous mixture out of the pump and into outlet line 186. The ozone-aqueous mixture is introduced into the water held in the container 112. This process continues for a desired time in which a concentration of ozone in the water is reached with will provide the disinfecting, sterilizing, or other treatment benefits to be achieved. In some embodiments a conventional timer, for example, in communication with the electric wires can be employed to control the time during which ozone is generated and passed into the liquid aqueous medium 122. A timer may also be used to control the treatment period and to provide a signal at a predetermined time indicating that treatment is complete and may be concluded. The period of time for treatment is typically in the order of about 0.1 hour to about 0.5 hours or about 1 hour or about 2 hours, preferably in the range of about 0.1 hour to about 0.5 hours. After the proper time has elapsed, the ozone generator and pump are stopped and the treated body part may be removed from the liquid aqueous medium. The liquid aqueous medium is then removed from the container body 112 and the apparatus 10 is now available for another therapeutic treatment.

The above-described treatment is preferably repeated at least once, and more preferably a plurality of times in order to achieve a desired treatment objective. For example, until a microbial infection is substantially reduced in severity or even eliminated.

Among other therapeutic benefits, the present apparatus and methods are very effective for treating fungus, bacterial or microorganism infection on human skin, for example on human feet. The amount of ozone included in the liquid aqueous medium is effectively controlled and the time of treating the body part is also controlled so that the treatment achieves substantial antibiotic/antifungal effectiveness while at the same time, minimizing or even eliminating any detrimental side effects of such treatment. It is important that not all of the human body is exposed to ozone and, that the ozone in the off gases from the liquid aqueous medium in the container may be destroyed before being introduced into the general environment surrounding the apparatus. Thus, an effective therapeutic treatment for bacteria, fungi and other microorganism infection is obtained in a safe and cost effective manner.

While this invention has been described in conjunction with the specific embodiments outlined above, it is evident that many alternatives, modifications and variations are apparent to those skilled in the art. Accordingly, the preferred embodiments of the invention as set forth above are intended to be illustrative and not limiting. Various changes may be made without departing from the spirit and scope of the invention.

1. An apparatus for treating a body part, the apparatus comprising:
a container adapted to hold a quantity of liquid aqueous medium and sized so that only a portion of an adult human body can be placed therein;
an ozone generator sized and adapted to produce an amount of ozone sufficient to ozonate the liquid aqueous medium in the container; and
a transfer assembly adapted to pass ozone-containing gas from said ozone generator to the liquid aqueous medium in said container, said transfer assembly including a water pump and a gas conduit connected to the ozone generator;
said transfer assembly being effective to cause ozone-containing gas to be drawn through the gas conduit and into the water pump and combined with an aqueous medium being provided to the water pump, and the ozone-containing gas combined with the aqueous medium is introduced into the liquid aqueous medium held in the container.

2. The apparatus of claim 1 wherein the transfer assembly further includes an inlet line structured to provide fluid communication between the container and the water pump to facilitate circulation of the liquid aqueous medium in the container through the water pump.

3. The apparatus of claim 1 wherein the body part is a human foot.

4. The apparatus of claim 1 wherein said container is sized to allow at least one foot of an adult human to be placed therein.

5. The apparatus of claim 1 wherein the transfer assembly and the ozone generator are effective to cause the liquid aqueous medium in the container to have a dissolved ozone concentration effective to treat a microbial infection on a human body part.

6. The apparatus of claim 1 which further comprises a cover member structured to be secured to said container so as to at least partially cover said container.

7. The apparatus of claim 1 which further comprises an ozone destruction assembly effective to destroy ozone gas released from the liquid aqueous medium in said container.

8. The apparatus of claim 7 wherein said ozone destruction assembly includes a fan and an ozone destroying element coupled thereto, said fan being positioned relative to the container so as to move ozone-containing gas released from the liquid aqueous medium in said container toward said ozone destroying element.

9. The apparatus of claim 8 wherein said ozone destroying element includes carbon effective to destroy ozone which contacts said carbon.

10. The apparatus of claim 6 which further comprises an ozone destruction assembly secured to the cover member and effective to destroy ozone gas released from the liquid aqueous medium in said container.

11. The apparatus of claim 10 wherein the ozone destruction assembly is secured to an inner surface of the cover member.

12. The apparatus of claim 10 wherein the water pump is operable to be effective to at least assist in drawing atmospheric air into the ozone generator.

13. An apparatus for treating a foot of a human being, the apparatus comprising:
a container adapted to hold a quantity of liquid aqueous medium and sized so that at least one foot of a human being can be placed therein;
an ozone generator sized and adapted to produce an amount of ozone sufficient to ozonate the liquid aqueous medium in the container; and
a transfer assembly adapted to pass ozone-containing gas from said ozone generator to the liquid aqueous medium in said container, said transfer assembly including a water pump and a gas conduit connected to the ozone generator;
said transfer assembly being effective to cause ozone-containing gas to be drawn through the gas conduit and into the water pump and combined with an aqueous medium being provided to the water pump, and the ozone-containing gas combined with the aqueous medium is introduced into the liquid aqueous medium held in the container.

14. The apparatus of claim 13 wherein the transfer assembly further includes an inlet line structured to provide fluid communication between the container and the water pump to facilitate circulation of the liquid aqueous medium in the container through the water pump.

15. The apparatus of claim 13 wherein the transfer assembly and the ozone generator are effective to cause the liquid aqueous medium in the container to have a dissolved ozone concentration effective to treat a microbial infection on a human foot.

16. The apparatus of claim 13 which further comprises a cover member structured to be secured to said container so as to at least partially cover said container.

17. The apparatus of claim 13 which further comprises an ozone destruction assembly effective to destroy ozone gas released from the liquid aqueous medium in said container.

18. The apparatus of claim 17 wherein said ozone destruction assembly includes a fan and an ozone destroying element coupled thereto, said fan being positioned relative to the container so as to move ozone-containing gas released from the liquid aqueous medium in said container toward said ozone destroying element.

19. The apparatus of claim 16 which further comprises an ozone destruction assembly secured to the cover member and effective to destroy ozone gas released from the liquid aqueous medium in said container.

20. The apparatus of claim 13 wherein the water pump is operable to be effective to at least assist in drawing atmospheric air into the ozone generator.
